(19) United States
(12) Patent Application Publication
(10) Pub. No.: US 2006/0199540 A1
(43) Pub. Date: Sep. 7, 2006

(54) WIRELESS TRANSCEIVING APPARATUS FOR AUDIO SIGNALS

(75) Inventors: Eric Oh-Yang, Miao-Lih (TW); Bor Kuan Lu, Miao-Lih (TW); Chi Jung Tsai, Miao-Lih (TW)

Correspondence Address: CONNOLLY BOVE LODGE & HUTZ LLP, SUITE 800, 1990 M STREET NW, WASHINGTON, DC, 20036-3425, US

(73) Assignee: ABOCOM SYSTEMS, INC., Hsinchu (TW)

(21) Appl. No.: 11/162,931

(22) Filed: Sep. 28, 2005

(30) Foreign Application Priority Data
Mar. 2, 2005 (TW) 094203187

(51) Int. Cl. H04B 7/00

(52) U.S. Cl. 455/41.2

(57) ABSTRACT

A wireless transceiving apparatus for audio signals comprises a bluetooth transceiver for transmitting and receiving digital signals, a bluetooth base-band unit electrically connected to the bluetooth transceiver, a processing unit electrically connected to the bluetooth base-band unit, and a codec unit electrically connected to the processing unit. The processing unit includes a first processing module for cell phone signals and a second processing module for stereo signals, and the processing priority of the first processing module is higher than the processing priority of the second processing module. The codec unit comprises an input port capable of being connected to a sound-to-voltage transducer such as a microphone, and an output port capable of being connected to a sound output device such as a headphone. The bluetooth transceiver can be coupled to an electrical device via a bluetooth transmitter.

### BACKGROUND OF THE INVENTION

(A) Field of the Invention

The present invention relates to a wireless transceiving apparatus for audio signals, and more particularly, to a bluetooth wireless transceiving apparatus capable of receiving stereo audio signals and sound signals from a cell phone.

(B) Description of the Related Art

The application of a conventional bluetooth earphone is a cell phone incorporating a bluetooth earphone, which allows a user to answer a phone call via the bluetooth earphone rather than to put the cell phone next to the ear directly. Particularly, the user can put the cell phone within a transmission boundary of the bluetooth earphone rather than carry the cell phone on body, so that the user can move around without any restriction and the radiation harm by the cell phone can be avoided.

However, a bluetooth earphone can only be used with a predetermined cell phone, and a user cannot use the bluetooth earphone to do anything except to receive sound signals from the cell phone. As the multi-media video and audio data widely appear in our daily life, the user needs a wireless transceiving apparatus to transmit multi-media video and audio data.

### SUMMARY OF THE INVENTION

A wireless transceiving apparatus for audio signals comprises a bluetooth transceiver for transmitting and receiving digital signals, a bluetooth base-band unit electrically connected to the bluetooth transceiver, a processing unit electrically connected to the bluetooth base-band unit, and a codec unit electrically connected to the processing unit. The processing unit includes a first processing module for cell phone signals and a second processing module for stereo signals, and the processing priority of the first processing module is higher than the processing priority of the second processing module.

The codec unit comprises an input port capable of being connected to a sound-to-voltage transducer such as a microphone, and an output port capable of being connected to a sound output device such as a headphone. The bluetooth transceiver can be coupled to an electrical device via a bluetooth transmitter, which includes a bluetooth transmitting unit capable of coupling to the bluetooth transceiver, a bluetooth base-band unit electrically connected to the bluetooth transmitting unit, a processing unit electrically connected to the bluetooth base-band unit, and an analog-to-digital converter electrically connected to the processing unit.

Compared with the prior art bluetooth earphone which can only work with a predetermined bluetooth cell phone, the present wireless transceiving apparatus can be coupled to a cell phone including a bluetooth transmitting unit or a bluetooth transmitter so that the present wireless transceiving apparatus can be used on/in a variety of electrical devices. The electrical device, such as a television, an MP3 player, or a DVD player, can be coupled to the present wireless transceiving apparatus via the bluetooth transmitting unit.

### BRIEF DESCRIPTION OF THE DRAWINGS

The primitive objectives and advantages of the present invention will become apparent upon reading the following description and upon reference to the accompanying drawings in which:

FIG. 1 illustrates a wireless transceiving apparatus according to one embodiment of the present invention; and

FIGS. 2 and 3 illustrates the application of the wireless transceiving apparatus according to one embodiment of the present invention.

### DETAILED DESCRIPTION OF THE INVENTION

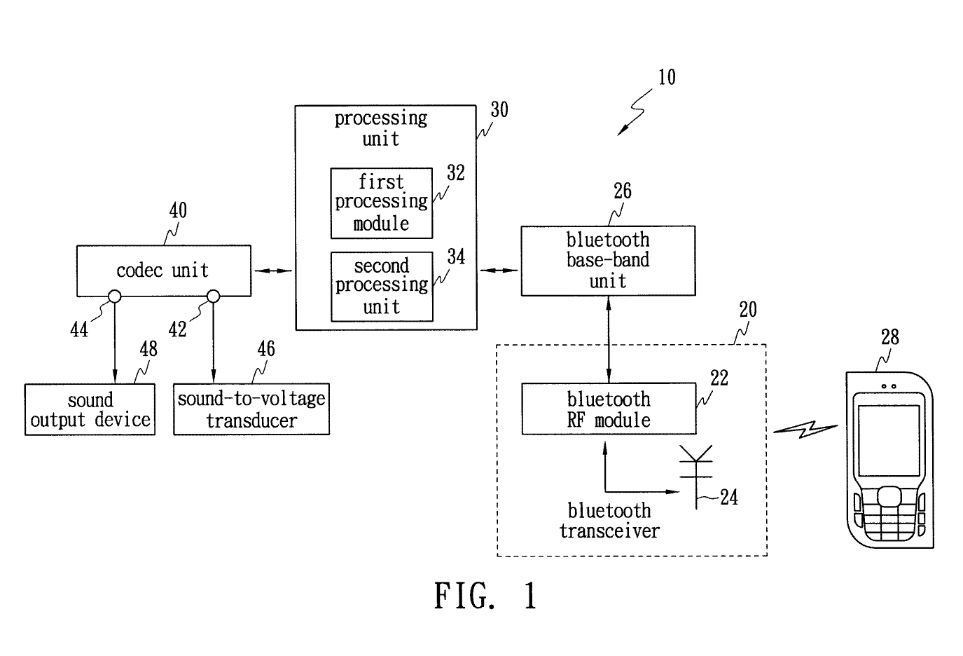

FIG. 1 illustrates a wireless transceiving apparatus 10 according to one embodiment of the present invention. The wireless transceiving apparatus 10 comprises a bluetooth transceiver 20 for transmitting and receiving digital signals, a bluetooth base-band unit 26 electrically connected to the bluetooth transceiver 20, a processing unit 30 electrically connected to the bluetooth base-band unit 26 and a codec unit 40 electrically connected to the processing unit 30. The processing unit 30 includes a first processing module 32 for cell phone signals and a second processing module 34 for stereo signals, and the processing priority of the first processing module 32 is higher than the processing priority of the second processing module 34.

The codec unit 40 comprises an input port 42 capable of being connected to a sound-to-voltage transducer 46 such as a microphone, and an output port 44 capable of being connected to a sound output device 48 such as a headphone. The bluetooth transceiver 20 includes a bluetooth RF module 20 and an antenna 24. When the wireless transceiving apparatus 10 couples to a cell phone 28, the first processing module of the processing unit 30 is activated to transmit sound signals from the cell phone 28 to the headphone 48, and to transmit sound signals from the microphone 46 to the cell phone 28.

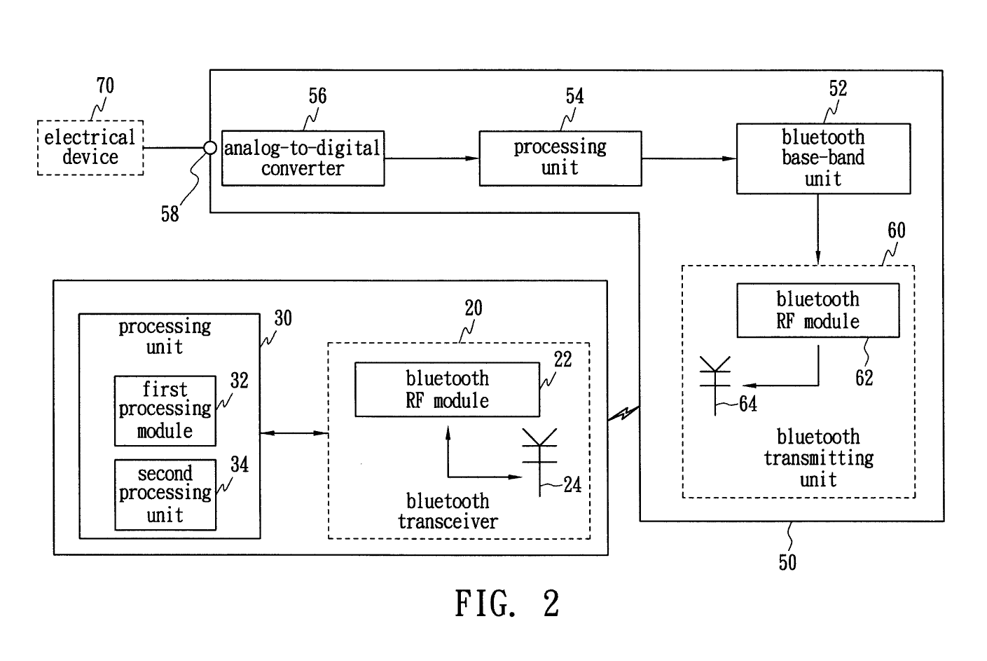

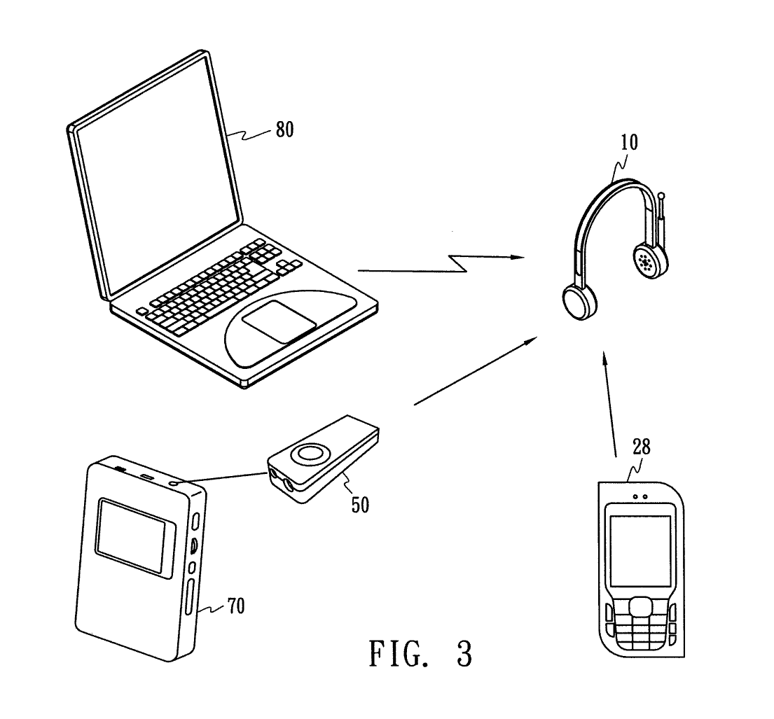

FIGS. 2 and 3 illustrate the application of the wireless transceiving apparatus 10 according to one embodiment of the present invention. The bluetooth transceiver 20 of the wireless transceiving apparatus 10 can be coupled to an electrical device 70 via a bluetooth transmitter 50, which includes a bluetooth transmitting unit 60 capable of coupling to the bluetooth transceiver 20, a bluetooth base-band unit 52 electrically connected to the bluetooth transmitting unit 60, a processing unit 54 electrically connected to the bluetooth base-band unit 52, and an analog-to-digital converter 56 electrically connected to the processing unit 54. The analog-to-digital converter 56 includes an input port 58, and the electrical device 70 can electrically connect to the processing unit 54 via the input port 58 and the analog-to-digital converter 56. The electrical device 70 can be a television, an MP3 player, or a DVD player. In addition, the wireless transceiving apparatus 10 can be coupled to a computer 80 including a bluetooth transceiver.

The analog-to-digital converter 56 converts sound signals from the electrical device into digital signals, which are then processed by the processing unit 54 and the bluetooth based-band unit 52, and the bluetooth transmitting unit 60 transmits the processed digital sound signals to the wireless transceiving apparatus 10. The wireless transceiving apparatus 10 uses the bluetooth wireless transceiver 20 to receive the digital sound signals from the bluetooth transmitter 50, and the digital sound signals are sent to the bluetooth base-band unit 26. The second processing module of the processing unit 30 is activated to transmit the digital sound signals to the codec unit 40 for performing code processing or decode processing before transmitting to the headphone 48.

Since the first processing module 32 possesses a higher processing priority than the second processing module 34, the first processing module 32 of the processing unit 30 will be activated first to process the digital sound signals from the cell phone 28 when the wireless transceiving apparatus 10 receives digital sound signals from both the bluetooth transmitter 50 and the cell phone 28 simultaneously.

Compared with the prior art bluetooth earphone, which can only work with a predetermined bluetooth cell phone, the present wireless transceiving apparatus can be coupled to a cell phone including a bluetooth transmitting unit or a bluetooth transmitter so that the present wireless transceiving apparatus can be used to a variety of electrical devices. The electrical device, such as a television, an MP3 player, or a DVD player, can be coupled to the present wireless transceiving apparatus via the bluetooth transmitting unit.

The above-described embodiments of the present invention are intended to be illustrative only. Numerous alternative embodiments may be devised by those skilled in the art without departing from the scope of the following claims.

What is claimed as new and desired to be protected by Letters Patent of the United States is:

1. A wireless transceiving apparatus for audio signals, comprising:
a bluetooth transceiver for transmitting and receiving digital signals;
a bluetooth base-band unit electrically connected to the bluetooth transceiver;
a processing unit electrically connected to the bluetooth base-band unit, wherein the processing unit includes a first processing module for cell phone signals and a second processing module for stereo signals; and
a codec unit electrically connected to the processing unit.

2. The wireless transceiving apparatus for audio signals of claim 1, wherein the codec unit comprises an input port capable of being connected to a sound-to-voltage transducer.

3. The wireless transceiving apparatus for audio signals of claim 2, wherein the sound-to-voltage transducer is a microphone.

4. The wireless transceiving apparatus for audio signals of claim 1, wherein the codec unit comprises an output port capable of being connected to a sound output device.

5. The wireless transceiving apparatus for audio signals of claim 4, wherein the sound output device is a headphone.

6. The wireless transceiving apparatus for audio signals of claim 1, wherein the processing priority of the first processing module is higher than the second processing module.

7. The wireless transceiving apparatus for audio signals of claim 1, wherein the bluetooth transceiver comprises a bluetooth RF module and an antenna.

8. The wireless transceiving apparatus for audio signals of claim 1, wherein the bluetooth transceiver can be coupled to a computer.

9. The wireless transceiving apparatus for audio signals of claim 1, wherein the bluetooth transceiver can be coupled to a cell phone.

10. The wireless transceiving apparatus for audio signals of claim 1, wherein the bluetooth transceiver can be coupled to an electrical device via a bluetooth transmitter.

11. The wireless transceiving apparatus for audio signals of claim 10, wherein the bluetooth transmitter comprises an analog-to-digital converter including an input port capable of being connected to the electrical device.

12. The wireless transceiving apparatus for audio signals of claim 10, wherein the electrical device is a television, an MP3 player, or a DVD player.
